(19) United States
(12) Patent Application Publication
(10) Pub. No.: US 2025/0063534 A1
(43) Pub. Date: Feb. 20, 2025

(54) SIDELINK POSITIONING IN CELLULAR SYSTEM

(71) Applicant: Nokia Technologies Oy, Espoo (FI)

(72) Inventors: Oana-Elena BARBU, Aalborg (DK); Nuno Manuel KIILERICH PRATAS, Gistrup (DK); Benny VEJLGAARD, Gistrup (DK); Johannes HARREBEK, Aalborg (DK); Jan Torst HVIID, Klarup (DK); Prajwal KESHAVAMURTHY, Munich (DE)

(21) Appl. No.: 18/721,709

(22) PCT Filed: Nov. 11, 2022
(86) PCT No.: PCT/EP2022/081567

§ 371 Date: Jun. 19, 2024

Related U.S. Application Data
(60) Provisional application No. 63/292,127, filed on Dec. 21, 2021.

(51) Int. Cl. H04W 64/00; H04W 8/22; H04W 92/18

(52) U.S. Cl. CPC H04W 64/00; H04W 8/22; H04W 92/18

(57) ABSTRACT

A solution for sidelink-assisted positioning of a terminal device. In an embodiment, a procedure in the terminal device includes transmitting, over a sidelink, a message including at least one information element requesting at least one anchor terminal device to report its location to the terminal device; receiving, over the sidelink from the at least one anchor terminal device, a location report including at least one information element indicating a location of the reporting anchor terminal device and an accuracy metric indicating accuracy of the location; determining a location estimate of the terminal device based on the accuracy metric and the location of the at least one anchor terminal device.

### FIELD

Various embodiments described herein relate to the field of wireless communications and, particularly, to utilizing sidelink communications for positioning a terminal device of a cellular communication system.

### BACKGROUND

A modern cellular communication system provides capability for terminal devices to communicate directly with one another over sidelink connections without the need for routing traffic via a base station. Two resource allocation modes have been specified in 3GPP (Third Generation Partnership Project), and a terminal device may be configured with one of them to perform its sidelink transmissions to one or more other terminal devices. In a first mode, a sidelink transmission resource is assigned by a network such as a serving access node to the terminal device, while in a second mode the terminal device is able to autonomously select its sidelink transmission resources.

The sidelink communications may be used for providing various communication services, and a positioning service is one of such services. In the positioning service, a terminal device having a need to determine its location may use other terminal devices in close proximity for the positioning. If the other terminal devices have determined their locations, they may help the terminal device in the positioning. A problem with this is that the locations of the terminal devices are estimates based on measurements and have a certain inaccuracy that may be variable. If the position of the terminal device is determined on the basis of inaccurate positions of the other terminal devices, the estimated location may be even more inaccurate.

### BRIEF DESCRIPTION

Some aspects of the invention are defined by the independent claims.

Some embodiments of the invention are defined in the dependent claims.

The embodiments and features, if any, described in this specification that do not fall under the scope of the independent claims are to be interpreted as examples useful for understanding various embodiments of the invention. Some aspects of the disclosure are defined by the independent claims.

According to an aspect, there is provided an apparatus comprising means for performing: transmitting, over a sidelink, a message comprising at least one information element requesting at least one anchor terminal device to report its location to the apparatus; receiving, over the sidelink from the at least one anchor terminal device, a location report comprising at least one information element indicating a location of the reporting anchor terminal device and an accuracy metric indicating accuracy of the location; determining a location estimate of the apparatus based on the accuracy metric and the location of the at least one anchor terminal device.

In an embodiment, the at least one information element of the message requests a plurality of anchor terminal devices to report their locations, and wherein the means are configured to receive a location report from the plurality of anchor terminal devices, each location report comprising said at least one information element indicating the location of the reporting anchor terminal device and the accuracy metric indicating the accuracy of the reported location, and to determine the location estimate on the basis of the plurality of reported locations and respective accuracy metrics.

In an embodiment, the means are configured to determine the location estimate of the apparatus by selecting, by using the accuracy metrics, a subset of the plurality of anchor terminal devices by preferring anchor terminal devices having more accurate reported location and by using the reported location of the subset to determine the location estimate, thus excluding from or down prioritizing in the determination of the location estimate the reported location of one or more anchor terminal devices not included in the subset.

In an embodiment, the means are configured to receive, from the at least one reporting anchor terminal device, the at least one information element indicating the location in the same message with the associated accuracy metric.

In an embodiment, the means are configured to use the estimated location of the apparatus to calculate a location correction information of the anchor terminal device and to transmit a location correction message to the anchor terminal device, the location correction message indicating the corrected location of the anchor terminal device.

In an embodiment, the means are configured to perform the location correction in response to receiving, from an anchor terminal device of the at least one anchor terminal device, a location correction request.

In an embodiment, the location correction request is comprised in the location report.

In an embodiment, the means are configured to compute the location correction information as two-dimensional or three-dimensional displacement vectors from the anchor terminal device's reported location.

In an embodiment, the means are configured to estimate the corrected location on the basis of measuring one or more signals received from the at least one anchor terminal device.

In an embodiment, the message further comprises at least one information element indicating location correction capability to the at least one anchor terminal device, wherein the location correction capability indicates whether or not the apparatus is capable of carrying out location correction for the at least one anchor terminal device.

In an embodiment, the at least one information element indicating the location correction capability further indicates, if the apparatus indicates its capability of carrying out the location correction, a type of location correction information amongst a plurality of different types of location correction.

In an embodiment, the plurality of different types of location correction information includes at least one of the following types: two-dimensional displacement correction, three-dimensional displacement correction, measurement data of at least one signal received from an anchor terminal device that is a target of the location correction.

According to an aspect, there is provided an apparatus comprising means for performing: receiving, over a sidelink from a terminal device, a message comprising at least one information element requesting the apparatus to report its location to the terminal device; transmitting, in response to the message and over the sidelink to the terminal device, a location report comprising at least one information element indicating a location of the apparatus and an accuracy metric indicating accuracy of the location.

In an embodiment, the means are configured to transmit to the terminal device a message comprising an information clement requesting the terminal device to correct the location of the apparatus, to receive from the terminal device a response comprising at least one information element indicating a location correction parameter, and to compute a corrected displacement to the location of the apparatus on the basis of the location correction parameter.

In an embodiment, the means are configured to receive a location correction parameter from a plurality of different terminal devices and to collate the plurality of location correction parameters when computing the corrected displacement to the location of the apparatus.

In an embodiment, the means comprises at least one processor and at least one memory storing instructions that cause said performance of the apparatus.

According to an aspect, there is provided a method comprising: transmitting, by a terminal device over a sidelink, a message comprising at least one information element requesting at least one anchor terminal device to report its location to the terminal device; receiving, by the terminal device over the sidelink from the at least one anchor terminal device, a location report comprising at least one information element indicating a location of the reporting anchor terminal device and an accuracy metric indicating accuracy of the location; determining, by the terminal device, a location estimate of the terminal device based on the accuracy metric and the location of the at least one anchor terminal device.

In an embodiment, the at least one information element of the message requests a plurality of anchor terminal devices to report their locations, and wherein the terminal device receives a location report from the plurality of anchor terminal devices, each location report comprising said at least one information element indicating the location of the reporting anchor terminal device and the accuracy metric indicating the accuracy of the reported location, and determines the location estimate on the basis of the plurality of reported locations and respective accuracy metrics.

In an embodiment, the terminal device determines the location estimate of the terminal device by selecting, by using the accuracy metrics, a subset of the plurality of anchor terminal devices by preferring anchor terminal devices having more accurate reported location and by using the reported location of the subset to determine the location estimate, thus excluding from or down prioritizing in the determination of the location estimate the reported location of one or more anchor terminal devices not included in the subset.

In an embodiment, the terminal device receives, from the at least one reporting anchor terminal device, the at least one information element indicating the location in the same message with the associated accuracy metric.

In an embodiment, the terminal device uses the estimated location of the terminal device to calculate a location correction information of the anchor terminal device and to transmit a location correction message to the anchor terminal device, the location correction message indicating the corrected location of the anchor terminal device.

In an embodiment, the terminal device performs the location correction in response to receiving, from an anchor terminal device of the at least one anchor terminal device, a location correction request.

In an embodiment, the location correction request is comprised in the location report.

In an embodiment, the terminal device computes the location correction information as two-dimensional or three-dimensional displacement vectors from the anchor terminal device's reported location.

In an embodiment, the terminal device estimates the corrected location on the basis of measuring one or more signals received from the at least one anchor terminal device.

In an embodiment, the message further comprises at least one information element indicating location correction capability to the at least one anchor terminal device, wherein the location correction capability indicates whether or not the terminal device is capable of carrying out location correction for the at least one anchor terminal device.

In an embodiment, the at least one information element indicating the location correction capability further indicates, if the terminal device indicates its capability of carrying out the location correction, a type of location correction information amongst a plurality of different types of location correction.

In an embodiment, the plurality of different types of location correction information includes at least one of the following types: two-dimensional displacement correction, three-dimensional displacement correction, measurement data of at least one signal received from an anchor terminal device that is a target of the location correction.

According to an aspect, there is provided a method comprising: receiving, by an anchor terminal device over a sidelink from a terminal device, a message comprising at least one information element requesting the anchor terminal device to report its location to the terminal device; transmitting, by the anchor terminal device in response to the message and over the sidelink to the terminal device, a location report comprising at least one information element indicating a location of the anchor terminal device and an accuracy metric indicating accuracy of the location.

In an embodiment, the anchor terminal device transmits to the terminal device a message comprising an information element requesting the terminal device to correct the location of the anchor terminal device, to receive from the terminal device a response comprising at least one information clement indicating a location correction parameter, and to compute a corrected displacement to the location of the anchor terminal device on the basis of the location correction parameter.

In an embodiment, the anchor terminal device receives a location correction parameter from a plurality of different terminal devices and collates the plurality of location correction parameters when computing the corrected displacement to the location of the anchor terminal device.

According to an aspect, there is provided a computer program product embodied on a computer-readable medium and comprising a computer program code readable by a computer for an anchor terminal device, wherein the computer program code configures the computer to carry out a computer process comprising: receiving, over a sidelink from a terminal device, a message comprising at least one information element requesting the anchor terminal device to report its location to the terminal device; transmitting, in response to the message and over the sidelink to the terminal device, a location report comprising at least one information element indicating a location of the anchor terminal device and an accuracy metric indicating accuracy of the location.

According to an aspect, there is provided a computer program product embodied on a computer-readable medium and comprising a computer program code readable by a computer for a terminal device, wherein the computer program code configures the computer to carry out a computer process comprising: transmitting, over a sidelink, a message comprising at least one information element requesting at least one anchor terminal device to report its location to the terminal device; receiving, over the sidelink from the at least one anchor terminal device, a location report comprising at least one information element indicating a location of the reporting anchor terminal device and an accuracy metric indicating accuracy of the location; determining a location estimate of the terminal device based on the accuracy metric and the location of the at least one anchor terminal device.

### LIST OF DRAWINGS

Embodiments are described below, by way of example only, with reference to the accompanying drawings, in which

FIG. 1 illustrates a wireless communication scenario to which some embodiments of the invention may be applied;

FIG. 2 illustrates a sidelink-assisted positioning scenario;

FIGS. 3 and 4 illustrate processes for sidelink assisted positioning according to some embodiments;

FIG. 5 illustrates a signalling diagram of another embodiment for sidelink assisted positioning;

FIGS. 6 and 7 illustrate embodiments for correcting a location of an anchor terminal device; and

FIGS. 8 and 9 illustrate block diagrams of structures of apparatuses according to some embodiments.

### DESCRIPTION OF EMBODIMENTS

The following embodiments are examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. A person skilled in the art will realize that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth R, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

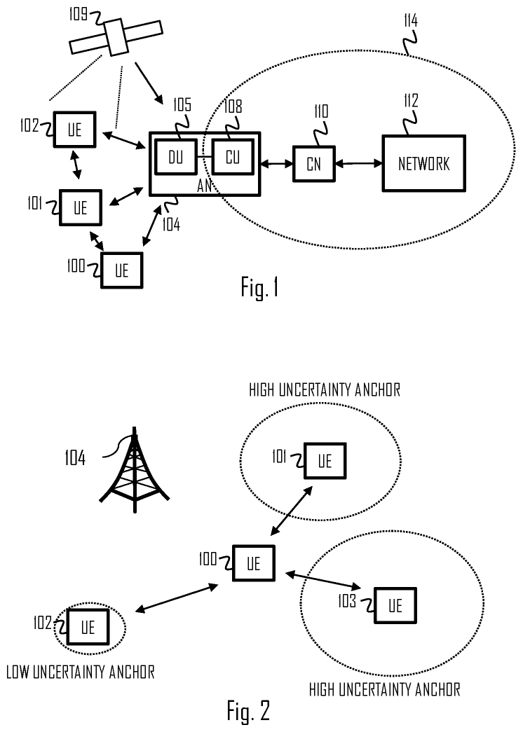

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows terminal devices or user devices 100 and 102 configured to be in a wireless connection on one or more communication channels in a cell with an access node (such as (e/g) NodeB) 104 providing the cell. (e/g) NodeB refers to an eNodeB or a gNodeB, as defined in 3GPP specifications. The physical link from a user device to a (e/g) NodeB is called uplink or reverse link and the physical link from the (e/g) NodeB to the user device is called downlink or forward link. It should be appreciated that (e/g) NodeBs or their functionalities may be implemented by using any node, host, server or access point etc. entity suitable for such a usage.

A communications system typically comprises more than one (e/g) NodeB in which case the (e/g) NodeBs may also be configured to communicate with one another over links, wired or wireless, designed for the purpose. These links may be used not only for signalling purposes but also for routing data from one (e/g) NodeB to another. The (e/g) NodeB is a computing device configured to control the radio resources of communication system it is coupled to. The NodeB may also be referred to as a base station, an access point, an access node, or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to user devices. The antenna unit may comprise a plurality of antennas or antenna elements. The (e/g) NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station. 5G specifications define two relay modes: out-of-band relay where same or different carriers may be defined for an access link and a backhaul link; and in-band-relay where the same carrier frequency or radio resources are used for both access and backhaul links. In-band relay may be seen as a baseline relay scenario. A relay node is called an integrated access and backhaul (IAB) node. It has also inbuilt support for multiple relay hops. IAB operation assumes a so-called split architecture having CU and a number of DUs. An IAB node contains two separate functionalities: DU (Distributed Unit) part of the IAB node facilitates the gNB (access node) functionalities in a relay cell, i.e. it serves as the access link; and a mobile termination (MT) part of the IAB node that facilitates the backhaul connection. A Donor node (DU part) communicates with the MT part of the IAB node, and it has a wired connection to the CU which again has a connection to the core network. In the multihop scenario, MT part (a child IAB node) communicates with a DU part of the parent IAB node.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilize cloud. In some applications, a user device may comprise a small portable device with radio parts (such as a watch, carphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6GHz, cm Wave and mm Wave, and also being capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words. 5G is planned to support both inter-RAT operability (such as LTE-5G) and inter-RI operability (inter-radio interface operability, such as below 6GHz-35 cmWave, below 6GHz—cmWave—mmWave—sub-THz). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and typically fully centralized in the core network. The low-latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 112, such as a public switched telephone network or the Internet, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 105) and non-real time functions being carried out in a centralized manner (in a centralized unit, CU 108).

It should also be understood that the distribution of functions between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or node B (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway. maritime, and/or aeronautical communications. Satellite communication may utilize geostationary earth orbit (GEO) satellite systems, but also low earth orbit (LEO) satellite systems, in particular mega-constellations (systems in which hundreds of (nano) satellites are deployed). Each satellite 109 in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g) NodeBs, the user device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

FIG. 1 further illustrates direct device-to-device communication links between the terminal devices 100, 101, 102. These links may correspond to the sidelinks described in Background and defined in 3GPP specifications for 5G, for example. And as described in Background, the sidelinks may be employed for various purposes, e.g. the positioning of a terminal device. FIG. 2 illustrates a situation where a terminal device 100 may employ other terminal devices 101, 102, 103 for positioning the terminal device via sidelink communications with the other terminal devices 101 to 103. Sidelink positioning support the following use cases: In a sidelink absolute positioning solution, the locations of the other terminal devices 101 to 103 (called anchor terminal devices in the following) are known, e.g. fixed. Accordingly, the absolute location may also be known (longitude and lattitude), e.g. via triangular positioning. In a sidelink relative positioning, the location of the terminal device 100 is relative to a mobile anchor terminal device whose location is also unknown or at least unreliable. Accordingly, the location of the terminal device 100 is only relative to the anchor terminal device(s) 101 to 103. In a sidelink assisted positioning, the terminal device may receive location report(s) from the anchor terminal devices that know their location (with a certain accuracy), and the location of the terminal device may be computed on the basis of the location report(s) and additional measurements performed by the terminal device 100 or by an access node 104 serving the terminal device 100. In this case, the absolute location of the terminal device may be acquired with accuracy dependent on the positioning accuracy of the anchor node(s).

In the measurements (ranging) used in the positioning, one or more of the following measurements may be performed by measuring a reference signal, for example: downlink time difference of arrival (DL-TDOA) measured by the terminal device 100, uplink time difference of arrival (UL-TDOA) measured by the access node from a signal received from the terminal device 100, downlink angle of departure (DL-AoD) measured by the terminal device 100, uplink angle of arrival (UL-AoA) measured by the access node from a signal received from the terminal device 100, and multi-cell round trip time (Multi-RTT) where a round-trip time of the terminal device 100 is measured towards each of multiple cells or access nodes (a type of trilateration).

As illustrated in FIG. 2 and described above, in the sidelink assisted positioning using the locations of the nearby anchor terminal devices, the positioning accuracy is dependent on the accuracy of the positioning of the anchor terminal device, particularly when the anchor terminal devices 101 to 103 are mobile. In the scenario of FIG. 2, the location of the anchor terminal device 102 is deemed to be accurate, as illustrated by a small uncertainty radius around the anchor terminal device 102, while the locations of the anchor terminal devices 101, 103 are rather inaccurate, as illustrated by large(r) uncertainty radii around the anchor terminal devices 101, 103. If the location of the terminal device 100 is estimated on the basis of the location of the anchor terminal device 102, the location estimate may be considered relatively accurate. On the other hand, if the location of the terminal device 100 is estimated on the basis of the locations of any one or both of the terminal devices 101, 103, the location estimate may be less accurate. Accordingly, reliable positioning of the 20) terminal device 100 would be advantageous in such a scenario.

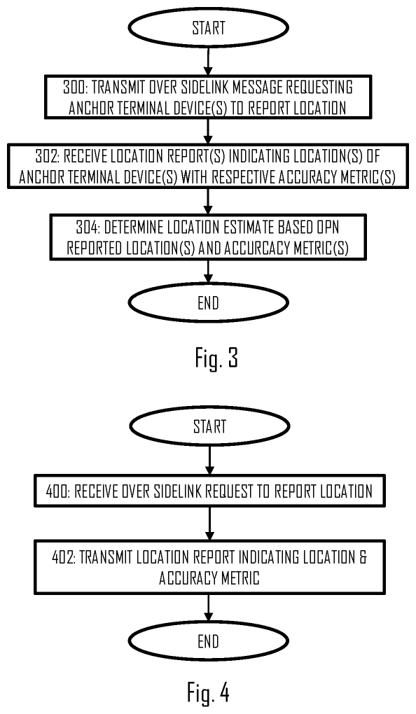

FIGS. 3 and 4 illustrate embodiments for sidelink-assisted positioning. FIG. 3 illustrates a method executed by an apparatus for the terminal device 100 that is being positioned, while FIG. 4 illustrates a method executed by an apparatus for an anchor terminal device, e.g. one of the terminal devices 101 to 103. In an embodiment, method discussed with reference to FIG. 3 is performed by the terminal device 100. In an embodiment, the method discussed with reference to FIG. 4 is performed by an anchor terminal device (e.g. terminal device 101, 102, 103).

Referring to FIG. 3, the method comprises transmitting (block 300), over a sidelink, a message comprising at least one information clement requesting at least one anchor terminal device to report its location to the apparatus; receiving (block 302), over the sidelink from the at least one anchor terminal devices, a location report comprising at least one information element indicating a location of the reporting anchor terminal device and an accuracy metric indicating accuracy of the location; and determining (block 304) a location estimate of the apparatus based on the accuracy metric and the location of the at least one anchor terminal device.

Referring to FIG. 4, the method comprises: receiving (block 400), over a sidelink from a terminal device, a message comprising at least one information element requesting the apparatus to report its location to the terminal device; and transmitting (block 402), in response to the message and over the sidelink to the terminal device, a location report comprising at least one information element indicating a location of the apparatus and an accuracy metric indicating accuracy of the location.

An advantage in the request-response procedure is that the sidelink-assisted positioning is triggered on-a-need basis. Therefore, unnecessary signalling may be reduced, while the terminal device 100 may gain the sidelink assistance whenever it has a need for sidelink-assisted positioning. An advantage in providing the accuracy metric is that the terminal device 100 may gain information on the positioning accuracy of the anchor nodes and use that information in the positioning. Therefore, more reliable location estimate may be gained. Below, embodiments of using the accuracy metric are provided.

In an embodiment, the anchor terminal device reports the location where it has determined to reside. In another embodiment, the anchor terminal device reports the location it knows to be close to its own location.

The accuracy metric can be understood to represent a positioning error or positioning precision of the anchor terminal device. It can be seen as a metric describing how close the estimated location is to the true location of the anchor terminal device. The accuracy metric may have the form of a mean square error, positioning variance/deviation, or a pseudo value describing the positioning accuracy. Accordingly, the positioning accuracy may be described or estimated via precision of the measurement values, and the precision may be represented by the mean square error and/or the variance/deviation of location estimates. Possible values of the accuracy metric and resolution of the accuracy metric may be designed to reflect the degree of the positioning error.

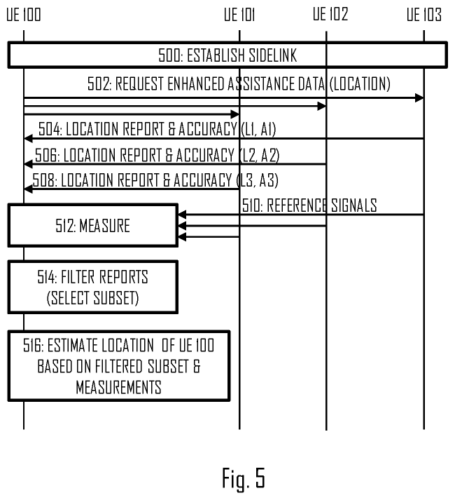

FIG. 5 illustrates a signalling diagram of an embodiment for the sidelink-assisted positioning between the terminal devices 100 to 103. FIG. 5 combines the processes of FIGS. 3 and 4, and illustrates further embodiments. In summary, the at least one information element of the message described above in connection with FIGS. 3 and 4 requests a plurality of anchor terminal devices 101 to 103 to report their locations, and the terminal device 100 receives a location report from the plurality of anchor terminal devices 101 to 103, each location report comprising said at least one information clement indicating the location of the reporting anchor terminal device 101 to 103 and the accuracy metric indicating the accuracy of the reported location, and the terminal device determines the location estimate on the basis of the plurality of reported locations and respective accuracy metrics.

Referring to FIG. 5, the terminal device(s) 100 to 103 establish the sidelink communications in block 500. Block 500 may comprise communication between the access node 104 and each terminal device 100 to 103, and initiation of protocol layers of the sidelinks (control plane and user plane). Further description on the establishment of the sidelinks and normal communication over the sidelink can be found in the literature (e.g. 3GPP specifications), and description thereof is omitted here.

The terminal device 100 may initiate a positioning procedure to determine its location and determine to carry out the positioning via the sidelink assisted positioning. As a consequence, the terminal device carries out block 300 (step 502 in FIG. 5) and transmits a message that may be called a request for enhanced assistance data. The message may comprise an information element indicating that the request for the enhanced assistance data concerns positioning and that the responding terminal device(s) are requested to report its/their location(s). The message may be a broadcast message, groupcast message, unicast message or a multicast message. The terminal devices 101 to 103 within the proximity of the terminal device 100 receive the message in block 400 (step 502).

Each terminal devices 101 to 103 receiving the message may determine whether or not to respond to the request. Upon determining to report its location, i.e. to act as the anchor terminal device, the anchor terminal device 101 to 103 may acquire its location (e.g. determined beforehand or positioning carried out in response to the message of step 502), and generate the location report that is transmitted in block 402. As described above, the location report may comprises at least one information element indicating the location of the anchor terminal device. Furthermore, the anchor terminal device may determine the accuracy metric that represents the positioning accuracy of the reported location. The accuracy metric may be computed on the basis of a deviation or variance in the positioning of the anchor terminal device. For example, the anchor terminal device may perform the positioning periodically or repeatedly and, thus, acquire multiple location samples. The deviation or variance of these samples (coordinates) may be used as an indicator of the accuracy, and the deviation or variance may be mapped to a value of the accuracy metric, and the value may be reported together with the reported location. This applies also to a case where the anchor terminal device estimates its location as a soft estimate including a location and its variance (or deviation). The anchor terminal device 101 may report its location L1 and respective accuracy metric A1 in step 504. the anchor terminal device 102 may reports its location L2 and respective accuracy metric A2 in step 506, and the anchor terminal device 103 may reports its location L3 and respective accuracy metric A3 in step 504. One or more other terminal devices detecting the message in step 502 may omit response to it.

The at least one information element in the location report may comprise two-dimensional or three-dimensional location coordinates of the reporting anchor terminal device. In another embodiment, the at least one information element also includes the accuracy metric, e.g. the at least one information element may carry a soft location of the anchor terminal device by defining a mean and variance of the reported location. The mean may indicate an average location within the positioning instances performed by the anchor terminal device, and the variation (or deviation) indicates the variance (or deviation) of the acquired location samples.

In an embodiment, the accuracy metric indicates (explicitly or implicitly) the positioning method used for positioning the anchor terminal device, e.g. a cellular communication system positioning (e.g. trilateration) or satellite positioning (global navigation satellite system. GNSS) or WiFi (IEEE 802.11) positioning. These positioning methods may be ranked (beforehand) in terms of accuracy. The ranking may be designed as suitable for the particular system and application. For example, in some applications the GNSS may be preferred over the cellular positioning while in other applications the situation may be opposite. For example, one positioning method may have higher accuracy than some other, thus leading to a higher rank. For example, satellite positioning may have higher rank than cellular communication system positioning.

Upon receiving the location reports in steps 504 to 508, the terminal device 100 may extract the locations L1 to L3 and accuracy metrics and store them. The terminal device may carry out measurement (block 512) of reference signals transmitted by the anchor terminal devices 101 to 103 and received by the terminal device 100 in step 510. The reference signal may be a pilot signal or any similar signal used for channel measurements and for computing the above-described for the positioning, e.g. the TDOA or angle of arrival.

In case multiple anchor terminal devices report its location, as in the embodiment of FIG. 5, the terminal device may filter the reports in block 514 on the basis of the accuracy metrics in the reports (block 514). Accordingly, locations reported with greater accuracy (as indicated by the accuracy metrics) may be preferred over locations reported with lower accuracy. In an embodiment, block 514 comprises determine selecting, by using the accuracy metrics received in steps 504 to 508, a subset of the plurality of anchor terminal devices by preferring anchor terminal device(s) having more accurate reported location and by using the reported location of the subset to determine the location estimate (block 516), thus excluding from the determination of the location estimate the reported location of one or more anchor terminal devices not included in the subset. The measurement of reference signals from the excluded anchor terminal devices may also be omitted from the estimation of the location of the terminal device 100. There may be other embodiments for filtering the reports, e.g. by including all the reported locations to the estimation of block 516 but assigning a lower weight to less accurate locations of the anchor terminal devices.

Block 514 may comprise selecting a determined number of anchor terminal devices providing the greatest positioning accuracy, indicated by the reported accuracy metrics. In an embodiment, the terminal device performs the selection of the subset in an iterative manner, and blocks 514 and 516 are performed jointly. The anchor terminal device may each transmit multiple location reports to get more statistics for block 516. Accordingly, the terminal device may perform the positioning repeatedly on the basis of the multiple location reports received from the anchor terminal devices. The terminal device 100 may first select N most accurate anchor terminal devices. Then, the terminal device 100 may carry out the positioning repeatedly and store variance of the location estimate. If the Then, the terminal device may select the most accurate anchor terminal device that was not within the set of N anchor terminal devices, and resume the positioning with the location reports from N+1 anchor terminal devices and again compute variance of thus acquired location estimates. If the variance decreases, the N+1^{th} is considered accurate enough. The terminal device may then select the next most accurate anchor terminal device (N+2) and repeat the positioning and variance monitoring. As long as the variance decreases with incrementation of the number of anchor terminal devices involved in the positioning, the process may continue. Upon detecting that the variance increases, the terminal device may stop the process and acquire the position of the previous iteration (before the variance of the location estimate increased) as the final location estimate of the terminal device 100.

Block 516 may comprise computing at least some of the following parameters on the basis of the reference signal received from an anchor terminal device in step 510 and measured in block 512: an angle-of-arrival of the reference signal, a path loss of the reference signal, and a round trip time between the terminal device and the anchor terminal device. The angle-of-arrival may be measured by using an antenna array and state-of-the-art spatial signal processing. The angle-of arrival indicates the direction of the anchor terminal device from the terminal device 100. The path loss can be measured by measuring a reception signal strength of the reference signal and comparing the reception signal strength with known transmission power of the reference signal. The round trip time or another communication delay metric may be computed with the knowledge of transmission time of the reference signal. The transmission time may be provided in a time stamp together with the reference signal, or by other synchronization means. The communication delay metric and the path loss are indicators of a distance between the anchor terminal device and the terminal device 100. With the knowledge of the direction and the distance, the relative location of the terminal device 100 with respect to the anchor terminal device can be computed in block 516 and, with the knowledge of the reported location of the anchor terminal device and the relative location, an absolute location of the terminal device 516 can be computed in block 516. By computing the location in this manner for multiple anchor terminal devices, multiple location samples are acquired by the terminal device 100, and these location samples may then be collated, for example by averaging them, optionally using weighting or by selecting the one that is associated with the greatest reported accuracy metric.

As described above, reporting anchor terminal devices may report the location and the associated accuracy metric in the same message in steps 504, 506, 508.

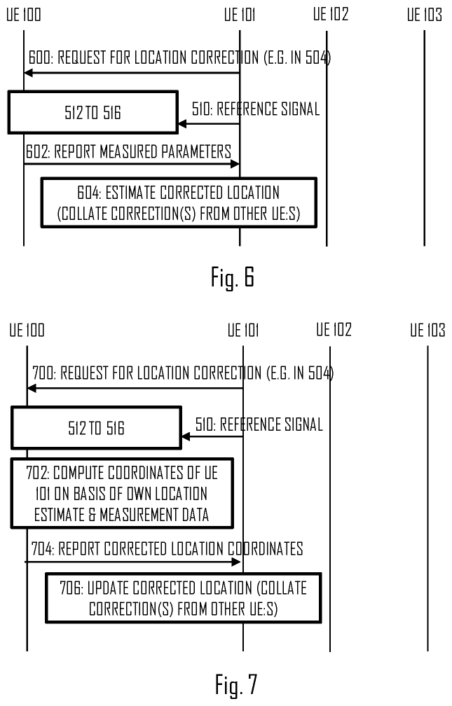

Since the location of the terminal device 100 is computed on the basis of the most accurate locations of the anchor terminal devices, e.g. the terminal device 102, the location of the terminal device is probably more accurate than the location(s) of the anchor terminal device(s) having low positioning accuracy, e.g. the terminal devices 101, 103. The more accurate location of the terminal device 100 may then be used to correct the inaccurate location of the anchor terminal devices 101, 103. In an embodiment, a terminal device transmits a location correction request in connection with the location report, and to use the estimated location of the apparatus to calculate location correction information of the anchor terminal device and to transmit a location correction message comprising the location correction information to the anchor terminal device, the location correction information indicating the corrected location of the anchor terminal device. FIGS. 6 and 7 illustrate such embodiments. In the embodiments of FIGS. 6 and 7, it is the anchor terminal device 101 that requests the correction, but is could be one of the other anchor terminal devices as well.

Referring to FIG. 6, the anchor terminal device 101 transmits in step 600 a message requesting for correcting the location of the anchor terminal device (a location correction request). Step 600 may be triggered upon observing that the inaccuracy metric exceeds a determined threshold.

In an embodiment, the location correction request is comprised in the location report transmitted in step 504. In such a case, the terminal device 100 may announce its capability to the location correction in the message transmitted in step 502. The capability may be announced by a certain value of an information clement dedicated to such signalling in the message. On the other hand, if the terminal device does not have the capability or willingness (e.g. due to low battery) for the location correction assistance, it may indicate the incapability by another value of the information element. In another embodiment, the location correction request is transmitted in a separate message. For example, a terminal device may initiate a sidelink assistance location correction service that is not bound to positioning of another terminal device. In such a case, for example, the terminal device 101 could transmit the location correction request to another anchor terminal device 102, 103.

Upon receiving the location correction request in step 600, the terminal device 100 may carry out block 512 and measure one or more of the above-described positioning parameters, e.g. the angle of arrival, path loss, or communication delay, and report the measured parameters to the anchor terminal device 101 in step 602. In this case, the communication delay may be indicated by a time stamp indicating reception timing of the reference signal of step 510. The anchor terminal device has knowledge of the transmission time of the reference signal and, thus, the delay can be computed in a straightforward manner. The above-described parameters may then be used as location correction parameters. Alternatively, raw measurement data may be reported in step 602. The terminal device 100 may also report the estimated location of the terminal device 100. By using the (more accurate) location of the terminal device and the measurement data or measured parameters, the anchor terminal device is able to compute its corrected location. The respective location correction information can be computed by first taking the absolute location of the terminal device 100, reported by the terminal device 100 in step 602, and then computing the distance and direction of the anchor terminal device 101 from the terminal device 100 by using the measurement data and/or the measured parameters, thus acquiring the corrected location represented by the location correction information. The anchor terminal device may carry out such a location correction procedure with multiple other terminal devices and, thus acquire multiple corrected locations. The anchor terminal device may then collate the multiple instances of the location correction information, e.g. compute an average or centre of mass of these corrected locations, to find an even better estimate for the corrected location.

The embodiment of FIG. 7 follows the same principle but, instead of reporting the measurements, the terminal device 100 computes the corrected location as two-dimensional or three-dimensional displacement vectors from the anchor terminal device's reported location or, alternatively, as direct 2D or 3D coordinates of the corrected location. Referring to FIG. 7, the location correction request may be communicated in step in the same manner as in step 600 above. Steps 510 to 516 may also be carried out in the above-described manner. In block 702, the terminal device then uses its location estimated in block 516 and the measurement data to compute the location of the anchor terminal device 101. Block 702 may correspond to block 604 without the collation, and the terminal device may carry out the same functions described above in connection with block 604 for the anchor terminal device 101. The terminal device 100 may thus compute the location correction information of the anchor terminal device 101 in terms of the corrected two or three-dimensional coordinates or as a correction vector, as described above. The terminal device 100 may then report the location correction information of the anchor terminal device 101 in step 704, and the anchor terminal device 101 may then update its location as the corrected location directly in block 706, or the anchor terminal device 101 may collate the corrected location with one or more other corrected locations received from the other terminal device(s).

In both embodiments of FIGS. 6 and 7, the location correction information of the anchor terminal device 101 is estimated on the basis of measuring one or more signals received by the terminal device 100 from the anchor terminal device 101.

The terminal devices 100 to 103 may support both embodiments of FIGS. 6 and 7. The terminal device 100 may indicate in step 500 (for example), if it indicates its capability of carrying out the location correction, a type of location correction information amongst a plurality of different types of location correction. The possible types to be indicated may include one or more of the following: a two-dimensional location correction vector representing displacement from the reported location of the anchor terminal device 101 (FIG. 7), a three-dimensional location correction vector representing displacement from the reported location of the anchor terminal device 101 (FIG. 7), and location correction parameters measured and reported by the terminal device 100 (FIG. 6). The terminal device 100 may indicate support for multiple of these types. The anchor terminal device 101 may then determine whether or not the supported types are acceptable to the anchor terminal device and then determine whether or not to transmit the location correction request on that basis. If the terminal device 100 indicates support for multiple types, the anchor terminal device may select one of them and indicate the selection in the location correction request.

In an embodiment using the filtering of block 514 or its embodiments, the terminal device may perform the location correction voluntarily to the anchor terminal devices excluded from the subset. As a consequence, the location correction may be initiated by the terminal device assisting in the location correction. Yet another embodiment of voluntary correction is that the terminal device 100 detects that the anchor terminal device 101 has requested a terminal device other than the terminal device 100 to assist in the location correction. The terminal device may then volunteer to the location correction by performing step 602 or 704.

In an embodiment using the location correction, the terminal device 100 may also include the accuracy metric of its location estimate computed in block 304 or 516 together with the correction information in step 602 or 704. The anchor terminal device may then use the accuracy metric when collating the location corrections acquired from the terminal devices assisting in correcting the location of the anchor terminal device 101. In yet another embodiment, the anchor terminal device 103 may monitor signalling between the terminal device 100 and the anchor terminal device 101 with respect to the location correction. Upon detecting that the anchor terminal device 101 has just undergone the location correction, the anchor terminal device 103 may request the anchor terminal device 101 to assist in correcting the location of the anchor terminal device 103 and carry out the location correction according to the procedure of FIG. 6 or 7. In such a case, since the location of the anchor terminal device 101 is readily known and corrected, block 516 may be skipped.

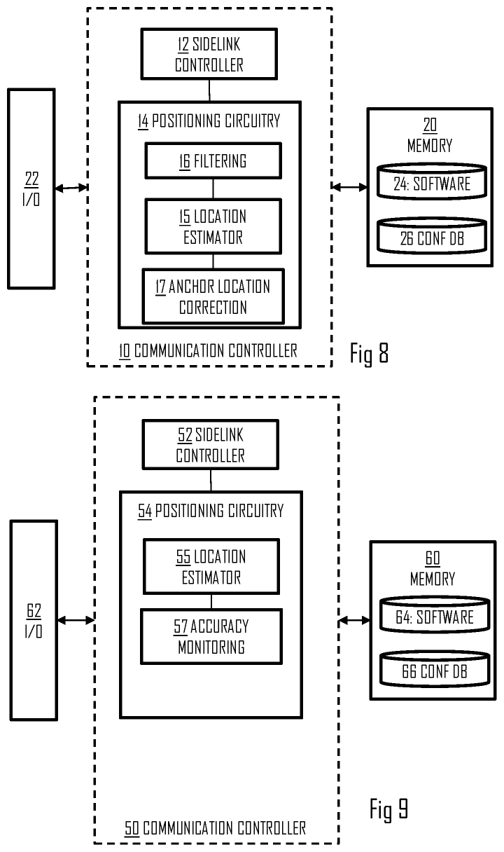

FIG. 8 illustrates an apparatus comprising means for carrying out the process of FIG. 3 or any one of the embodiments described above. The apparatus may comprise a processing circuitry, such as at least one processor, and at least one memory 20 including computer program code or computer program instructions (software) 24, wherein the at least one memory and the computer program code (software) are configured, with the at least one processor, to cause the apparatus to carry out the process of FIG. 3 or any one of its embodiments described above. The apparatus may be for the terminal device 100. The apparatus may be a circuitry or an electronic device realizing some embodiments of the invention in the terminal device 100. The apparatus carrying out the above-described functionalities may thus be comprised in such a device, e.g. the apparatus may comprise a circuitry such as a chip, a chipset, a processor, a micro controller, or a combination of such circuitries for the terminal device 100. The at least one processor or a processing circuitry may realize a communication controller 10 controlling communications in a radio interface of the cellular communication system in the above-described manner. The communication controller may be configured to establish and manage radio connections, transfer of data over radio resource control (RRC) connections with the access node 104.

The communication controller 10 may comprise a sidelink controller 12 configured to establish, manage, and terminate sidelink radio connections between the terminal device 100 and the other terminal devices 101 to 103. The sidelink controller may carry out step 500.

The communication controller 10 may comprise a positioning circuitry 14 configured to carry out the positioning of the apparatus by utilizing the sidelink-assisted positioning according to the procedure of FIG. 3 or any one of the embodiments thereof. The positioning circuitry may comprise a location estimator 15 that may trigger the sidelink-assisted positioning, thus causing the apparatus to transmit the request in block 300. Upon receiving multiple location reports from the anchor terminal devices, a filtering circuitry 16 may analyze the accuracy metrics in the reports and prioritize the location estimates in the reports in the above-described manner. Thereafter, the location estimator may use the prioritized reported locations of the anchor terminal device and the additional measurements performed by the apparatus to estimate the location of the apparatus.

In some embodiments, the positioning circuitry may further comprise an anchor location correction circuitry 17 configured to perform, upon receiving a request from an anchor terminal device or on its own volition, the location correction procedure to assist in correcting an inaccurate location estimate provided by the anchor terminal device according to the above-described embodiments.

The apparatus may further comprise an application processor (not shown) executing one or more computer program applications that generate a need to transmit and/or receive data through the communication controller 10. The application processor may form an application layer of the apparatus. The application processor may execute computer programs forming the primary function of the apparatus. For example, if the apparatus is a sensor device, the application processor may execute one or more signal processing applications processing measurement data acquired from one or more sensor heads. If the apparatus is a computer system of a vehicle, the application processor may execute a media application and/or an autonomous driving and navigation application. Positioning of the apparatus may be beneficial for all these applications. The application processor may thus generate a command for executing the process of FIG. 3.

The memory 20 may be implemented using any suitable data storage technology, such as semiconductor-based memory devices, flash memory, magnetic memory devices and systems, optical memory devices and systems, fixed memory and removable memory. The memory 20 may comprise a configuration database 26 for storing configuration parameters, e.g. which positioning parameters to use in positioning the terminal device 100.

The apparatus may further comprise a communication interface 22 comprising hardware and/or software for providing the apparatus with radio communication capability, as described above. The communication interface 22 may include, for example, an antenna, one or more radio frequency filters, a power amplifier, and one or more frequency converters. The communication interface 22 may comprise hardware and software needed for realizing the radio communications over the radio interface, e.g. according to specifications of an LTE or 5G radio interface.

FIG. 10 illustrates an apparatus comprising a processing circuitry, such as at least one processor, and at least one memory 60 including a computer program code or computer program instructions (software) 64, wherein the at least one memory and the computer program code or computer program instructions are configured, with the at least one processor, to cause the apparatus to carry out functions of the anchor terminal device in the process of FIG. 4 or any one of its embodiments described above. The apparatus may be for the anchor terminal device. The apparatus may be a circuitry or an electronic device realizing some of the above-described embodiments in the anchor terminal device. The apparatus carrying out the above-described functionalities may thus be comprised in such a device, e.g. the apparatus may comprise a circuitry such as a chip, a chipset, a processor, a micro controller, or a combination of such circuitries for the anchor terminal device. In other embodiments, the apparatus is the anchor terminal device. The at least one processor or a processing circuitry may realize a communication controller 50 controlling communications in the above-described manner. The communication controller may be configured to establish and manage radio connections and transfer of data over the radio connections, including the RRC connections and the sidelink connections. The communication controller may comprise a sidelink controller 52 similar to or identical with the sidelink controller 12.

The communication controller 50 may further comprise a positioning circuitry 54 configured to monitor the location of the apparatus or to carry out positioning of the apparatus according to any one of the above-described embodiments. The positioning circuitry 54 may comprise a location estimator 55 configured to carry out the positioning of the apparatus by using any one of the state-of-the-art positioning methods. Such include GNSS-based positioning, trilateration by using multiple access nodes of the cellular communication system or other radio devices at known locations, or any other positioning solution. The positioning circuitry 54 may further comprise an accuracy monitoring circuitry 57 configured to monitor the positioning accuracy or, equivalently, the positioning error in the above-described manner. The sidelink controller 52 may then determine whether or not to use the location estimated by the location estimator to assist the terminal device 100 in the sidelink-assisted positioning of the terminal device 100.

The memory 60 may be implemented using any suitable data storage technology, such as semiconductor-based memory devices, flash memory, magnetic memory devices and systems, optical memory devices and systems, fixed memory and removable memory. The memory 60 may comprise a configuration database 66 for storing configuration parameters, e.g. the accuracy metric.

The apparatus may further comprise a radio frequency communication interface 62 comprising hardware and/or software for providing the apparatus with radio communication capability with the other terminal devices, as described above. The communication interface 62 may include, for example, an antenna array, one or more radio frequency filters, a power amplifier, and one or more frequency converters. The communication interface 62 may comprise hardware and software needed for realizing the radio communications over the radio interface, e.g. according to specifications of an LTE or 5G radio interface.

As used in this application, the term ‘circuitry’ refers to one or more of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of circuitry applies to uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described in FIG. 3, 7, or any of the embodiments thereof may also be carried out in the form of one or more computer processes defined by one or more computer programs. The computer program(s) may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units. References to computer-readable program code, computer program, computer instructions, computer code etc. should be understood to express software for a programmable processor such as programmable content stored in a hardware device as instructions for a processor, or as configured or configurable settings for a fixed function device, gate array, or a programmable logic device.

Embodiments described herein are applicable to wireless networks defined above but also to other wireless networks. The protocols used, the specifications of the wireless networks and their network elements develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. Embodiments are not limited to the examples described above but may vary within the scope of the claims.

1.-33. (canceled)

34. An apparatus comprising means for performing:
transmitting, over a sidelink, a message comprising at least one information element requesting at least one anchor terminal device to report its location to the apparatus;
receiving, over the sidelink from the at least one anchor terminal device, a location report comprising at least one information element indicating a location of the reporting anchor
terminal device and an accuracy metric indicating accuracy of the location; determining a location estimate of the apparatus based on the accuracy metric and the location of the at least one anchor terminal device.

35. The apparatus of claim 34, wherein the at least one information element of the message requests a plurality of anchor terminal devices to report their locations, and wherein the means are configured to receive a location report from the plurality of anchor terminal devices, each location report comprising said at least one information element indicating the location of the reporting anchor terminal device and the accuracy metric indicating the accuracy of the reported location, and to determine the location estimate on the basis of the plurality of reported locations and respective accuracy metrics.

36. The apparatus of claim 35, wherein the means are configured to determine the location estimate of the apparatus by selecting, by using the accuracy metrics, a subset of the plurality of anchor terminal devices by preferring anchor terminal devices having more accurate reported location and by using the reported location of the subset to determine the location estimate, thus excluding from or down prioritizing in the determination of the location estimate the reported location of one or more anchor terminal devices not included in the subset.

37. The apparatus of claim 34, wherein the means are configured to receive, from the at least one reporting anchor terminal device, the at least one information element indicating the location in the same message with the associated accuracy metric.

38. The apparatus of claim 34, wherein the means are configured to use the estimated location of the apparatus to calculate a location correction information of the anchor terminal device and to transmit a location correction message to the anchor terminal device, the location correction message indicating the corrected location of the anchor terminal device.

39. The apparatus of claim 38, wherein the means are configured to perform the location correction in response to receiving, from an anchor terminal device of the at least one anchor terminal device, a location correction request.

40. The apparatus of claim 39, wherein the location correction request is comprised in the location report.

41. The apparatus of claim 39, wherein the means are configured to compute the location correction information as two-dimensional or three-dimensional displacement vectors from the anchor terminal device's reported location.

42. The apparatus of claim 38, wherein the means are configured to estimate the corrected location on the basis of measuring one or more signals received from the at least one anchor terminal device.

43. The apparatus of claim 34, wherein the message further comprises at least one information element indicating location correction capability to the at least one anchor terminal device, wherein the location correction capability indicates whether or not the apparatus is capable of carrying out location correction for the at least one anchor terminal device.

44. The apparatus of claim 43, wherein the at least one information element indicating the location correction capability further indicates, if the apparatus indicates its capability of carrying out the location correction, a type of location correction information amongst a plurality of different types of location correction.

45. The apparatus of claim 44, wherein the plurality of different types of location correction information includes at least one of the following types: two-dimensional displacement correction, three-dimensional displacement correction, measurement data of at least one signal received from an anchor terminal device that is a target of the location correction.

46. An apparatus comprising means for performing:
receiving, over a sidelink from a terminal device, a message comprising at least one information element requesting the apparatus to report its location to the terminal device;
transmitting, in response to the message and over the sidelink to the terminal device, a location report comprising at least one information element indicating a location of the apparatus and an accuracy metric indicating accuracy of the location.

47. The apparatus of claim 46, wherein the means are configured to transmit to the terminal device a message comprising an information element requesting the terminal device to correct the location of the apparatus, to receive from the terminal device a response comprising at least one information element indicating a location correction parameter, and to compute a corrected displacement to the location of the apparatus on the basis of the location correction parameter.

48. The apparatus of claim 46, wherein the means are configured to receive a location correction parameter from a plurality of different terminal devices and to collate the plurality of location correction parameters when computing the corrected displacement to the location of the apparatus.

49. The apparatus of claim 46, wherein the means comprises at least one processor and at least one memory storing instructions that cause said performance of the apparatus.

50. A method comprising:
transmitting, by a terminal device over a sidelink, a message comprising at least one information element requesting at least one anchor terminal device to report its location to the terminal device;
receiving, by the terminal device over the sidelink from the at least one anchor terminal device, a location report comprising at least one information element indicating a location of the reporting anchor terminal device and an accuracy metric indicating accuracy of the location;
determining, by the terminal device, a location estimate of the terminal device based on the accuracy metric and the location of the at least one anchor terminal device.

51. The method of claim 50, wherein the at least one information element of the message requests a plurality of anchor terminal devices to report their locations, and wherein the terminal device receives a location report from the plurality of anchor terminal devices, each location report comprising said at least one information element indicating the location of the reporting anchor terminal device and the accuracy metric indicating the accuracy of the reported location, and determines the location estimate on the basis of the plurality of reported locations and respective accuracy metrics.

52. The method of claim 51, wherein the terminal device determines the location estimate of the terminal device by selecting, by using the accuracy metrics, a subset of the plurality of anchor terminal devices by preferring anchor terminal devices having more accurate reported location and by using the reported location of the subset to determine the location estimate, thus excluding from or down prioritizing in the determination of the location estimate the reported location of one or more anchor terminal devices not included in the subset.

53. The method of claim 50, wherein the terminal device receives, from the at least one reporting anchor terminal device, the at least one information element indicating the location in the same message with the associated accuracy metric.
